(19) United States
(12) Patent Application Publication
(10) Pub. No.: US 2025/0388372 A1
(43) Pub. Date: Dec. 25, 2025

(54) REUSABLE CLOSURES

(71) Applicant: OBRIST CLOSURES SWITZERLAND GMBH, Muttenz (DE)

(72) Inventors: Frédéric CHAVE, Saint-Georges-de-Reneins (FR); Thierry BERNET, Lohne (DE)

(21) Appl. No.: 18/880,598

(22) PCT Filed: Jun. 27, 2023
(86) PCT No.: PCT/EP2023/067544

§ 371 Date: Jan. 2, 2025

(30) Foreign Application Priority Data
Jul. 9, 2022 (GB) 2210103.4

(51) Int. Cl. B65D 47/08; B65D 5/74

(52) U.S. Cl. CPC B65D 47/088; B65D 5/748

(57) ABSTRACT

A reusable closure is provided. The closure includes a base and a lid, wherein the base comprises a flowable medium dispensing passage extending along the longitudinal length of the base between the first end of the base and a point beyond the second end of the base, wherein, in use, the dispensing passage is adapted to communicate with the dispensing opening of the container. The base comprises first coupling elements adapted to mate with second coupling means forming part of the dispensing channel of the container such that, in use, the reusable container is attached to the container. The base comprises one or more cutting elements configured to break a scaling membrane situated within the opening of the container. Kits and methods for attaching a reusable closure to a dispensing passage of a container are also provided.

The present disclosure relates to reusable closures. A reusable closure may be configured to be attached to a container, while such container is arranged for storing a fluid or another flowable medium, which can be dispensed through a dispensing passage of the closure.

### BACKGROUND

Plastic containers that are currently available typically require two separate components. The two main components of the container are the container body and a cap or closure which is adapted for mounting on the container body for sealing a space formed within the container body.

Containers are known which have a membrane or web closing a container's dispensing opening and, for example, a tear ring attached to such membrane or web. In many instances, the tear ring is recessed in the dispensing opening, and can be grasped only by inserting a finger into it and pulling it out of the opening to tear and remove the membrane or web and open the spout for use. One difficulty with many such tear rings is that a person with large fingers, or a person using one of his or her larger fingers or a thumb, or a person lacking in dexterity, has difficulty inserting a finger in the recessed ring. The inaccessible edge of the recessed ring cannot be manipulated. The ring is thus difficult to lift out of place so it can be grasped more firmly.

Closures are generally snap-type caps or screw-type caps which can be removed and attached again with respect to the dispensing opening of the same container to which the closure is intended to be attached. Such closures may include tamper-evident features to enable a retailer or consumer to determine whether the closure has been opened before.

Conventional closures have certain limitations. For example, the closures themselves can be quite costly to produce, frequently being formed from two or more separate parts formed in two or more separate molds using two or more separate injection molding processes and two or more different materials.

A further problem with many closures is the requirement for difficult and expensive assembly operations for finishing the closures and installing them on containers. These operations can require expensive tooling. Additionally, once the material within the container is exhausted, the closure and the container may be discarded together. This is not a very sustainable solution.

Examples of the present disclosure seek to at least partially reduce one or more of the aforementioned problems.

### SUMMARY

According to a first aspect, a reusable closure adapted to be removably connected to a dispensing opening of a container is provided. The container is made of paperboard, fiberboard or cardboard. The reusable closure comprises: a base and a lid, the base and the lid being joint together by a hinge such that the lid is movable between an open position and a closed position, wherein the base extends longitudinally from a first end to a second end, wherein the base comprises: a flowable medium dispensing passage extending along the longitudinal length of the base between the first end of the base and the second end of the base, wherein, in use, the dispensing passage is adapted to communicate with the dispensing opening of the container. The base further comprises first coupling elements adapted to mate with second coupling elements forming part of the dispensing opening of the container such that, in use, the removably reusable closure is attached to the container and one or more cutting elements configured to break a sealing membrane situated within the opening of the container when the closure is attached to the container such that a flowable medium contained in the container can be dispensed through the dispensing opening of the container.

According to this first aspect, a reusable and removable closure which is configured to provide the function to avoid flowable medium leakage during transport, or handling on containers made of paperboard, fiberboard or cardboard is provided. To this end, the closure comprises first coupling elements which are configured to mate with second coupling elements provided in the opening of the container such that, in use, the closure closes off the opening of the container.

In this respect, the container further comprises a sealing element configured to be coupled within the dispensing opening such that the dispensing opening is sealed and the flowable product cannot be dispensed via the dispensing opening and pollution cannot pass through the dispensing opening towards the flowable product stored within the container, when the closure is not attached to the container.

In this respect, by the simple operation of attaching the reusable closure to the container via corresponding coupling elements, the sealing element can be easily broken using the cutting elements and thus the flowable medium contained in the container can be dispensed through the dispensing opening of the container (and thus through the dispensing passage of the closure in fluid communication with the dispensing opening of the container).

When the flowable medium is exhausted, the closure can be detached from the container. A new container can then be attached to the closure and the now empty container can be sent for re-filling or recycling (particularly, a container made of paperboard, fiberboard or cardboard can be easily recycled). Meanwhile the closure is re-used in the new container.

In summary, a closure which is simple, cost-effective, light, and with a high degree of sustainability is provided.

In a further aspect, a kit is provided. The kit comprises a container comprising an interior space for housing a flowable product and a dispensing opening for dispensing the flowable product contained in the interior space, wherein the container is made of paperboard, fiberboard or cardboard. The kit further comprises a reusable closure according to the first aspect.

The container is made of a recyclable material e.g., cardboard. Cardboard is extremely lightweight, especially when compared to other materials, such as plastic. Cardboard is also environmentally friendly since it may easily be recycled. As result, the container the assembly can be easily recycled after use and, at the same time, the closure can be reused with another recharge or new container.

According to another aspect, method for attaching a reusable closure to a dispensing passage of a container is provided: The method comprise providing a reusable closure according to the first aspect. The method further comprises providing a first container comprising an interior space for housing a flowable product and a dispensing opening for dispensing the flowable product contained in the interior space, wherein the first container is made of paperboard, fiberboard, or cardboard, coupling a sealing element within the dispensing opening of the container such that the dispensing opening is sealed and the flowable product cannot pass through the dispensing opening, bringing the reusable closure and the first container in proximity of each other, pushing the reusable closure towards the dispensing opening of the container such that closure is coupled to the dispensing opening of the container and rotatably displacing the closure in the clockwise direction with respect to the first container such that the sealing element is broken using the cutting elements of the closure and the reusable closure is attached to the dispensing opening of the first container.

### BRIEF DESCRIPTION OF DRAWINGS

Non-limiting examples of the present disclosure will be described in the following, with reference to the appended drawings, in which:

FIG. 1a schematically illustrates a perspective view of an example of a closure in an “open” configuration;

FIG. 1b schematically illustrates a section of the closure of FIG. 1a taken along line A-A;

FIG. 2 schematically illustrates an example of a hinge which may form part of the closure described with reference to FIG. 1a and FIG. 1b;

FIGS. 3a-3f illustrate various steps of an example of a method for removably attaching a closure (which may be the same or similar to the one described with reference to FIGS. 1a-b) to a flowable medium container; and

FIG. 4 schematically illustrates a perspective view of another example of a closure in an “open” configuration.

### DETAILED DESCRIPTION OF EXAMPLES

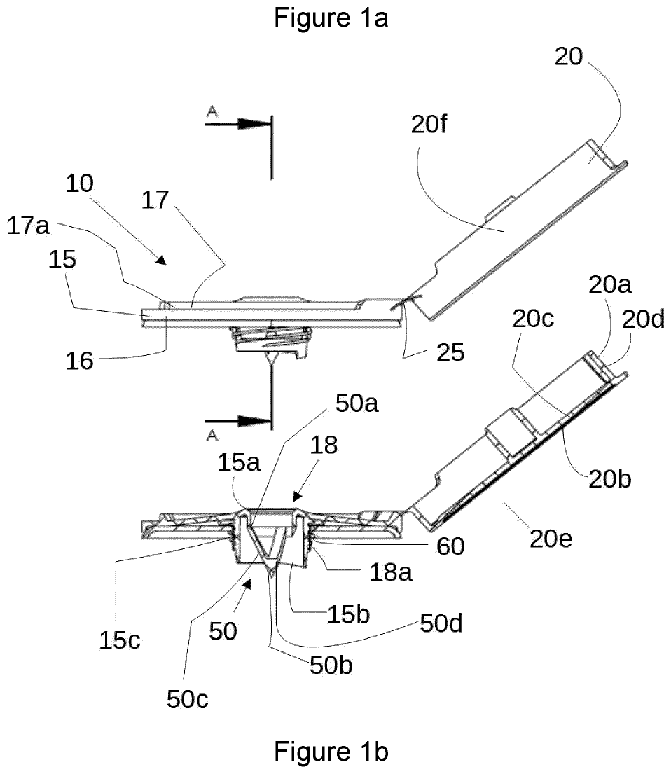

FIG. 1a schematically illustrates a perspective view of an example of a closure in an “open” configuration. FIG. 1b schematically illustrates a section of the closure of FIG. 1a taken along line A-A. As shown in these figures, the closure 10 may comprise a base 15 and a lid 20. The base 15 in this example is a substantially circular base.

The closure 10 may be a flip-top closure which may be reusable i.e., the closure may be connected to a container containing a flowable medium and, once the container is empty, the closure may be disconnected and attached again to a new container. This will be explained with more detail later on.

In examples, the closure 10 may be a one-piece closure i.e., it may be manufactured as a single piece and can be made of a single material. A one-piece mono material solution is light-weight and fully recyclable with current recycling processes.

The closure 10 as shown in these figures is moulded from a synthetic plastics material in a suitable mould. Such a mould has cavity defining the features of the depicted closure. The closure may be made of recyclable or recycled plastic materials. Closure may be formed from a blend of a recycled plastics material and a non-recycled plastics material. Such a blend may preferably contain at least 30% recycled plastics material. In some other examples, such a blend may contain at least 50% recycled plastics material.

The size of the base 15 (and the corresponding lid 20) may be adjusted in accordance with its objective and can thus be varied for different flowable product applications.

The base 15 and the lid 20 may be connected by a hinge 25 situated at a “back part” of the closure 1. This way, the lid 20 may be displaced between an “open” position and a “closed” position with respect to the base 15.

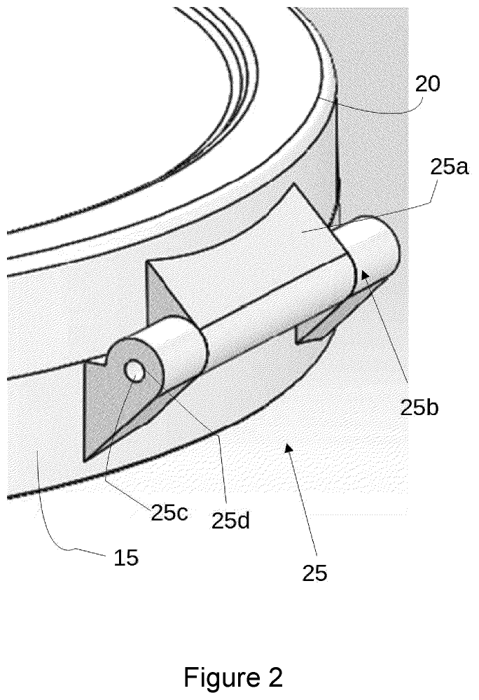

As shown in FIG. 2, the hinge 25 may be a butterfly hinge. Butterfly hinge 25 functions as a movable hinge that enables the lid 20 assembly to move relative to the base 15. Butterfly hinge 25 can include a wing 25a. A first end of the wing 25a may be attached to the lid 20 and the second end of the wing 25 may be rotatably attached to a pivot 25b using one or more pins. In this example, a pin 25c may be passed through a first hole 25d defined in a first part of the pivot, a second hole (not visible) defined in the wing 25a and a third hole (not visible) defined in a second part of the pivot. Thus, the pin 25c may define a support axis about which the lid 20 may pivot with respect to the base 15.

Again in FIGS. 1a and 1b, the base 15 includes a generally cylindrical sidewall 16 and an annular top platform 17. A generally cylindrical outer skirt or sidewall 17a depends from the periphery of the platform 17. The generally cylindrical outer skirt or sidewall 17a is situated radially inwardly with respect to the generally cylindrical sidewall 16.

In examples not shown, in the “front part” of the closure 10 (opposite to the above-commented “back part” and thus opposite to the hinge 25) a slot may be provided. The slot may form a female coupling element and is adapted to receive and mate with a further connector or male coupling element located e.g., in the lid. In some examples, in order to provide a sealing engagement of the male and female coupling members, a snap fit may be used.

As can be seen in FIG. 1b, the base 15 extends longitudinally between a first end 15a and a second end 15b. In the center of the platform 17, a cylindrical dispensing channel 18 is provided. The dispensing channel 18 is defined along the longitudinal length of the base 15 between the first end 15a of the base and the second end 15b of the base. A through-hole is formed in the base. The dispensing channel 18 is suitable to dispense a flowable medium previously stored in a container to which the closure, in use, is attached, as will be described later on.

A longitudinal axis of the dispensing channel 18 may be situated at angle of 90 degrees with respect to the plane defined by the annular top platform 17. In any case, the angle may be any suitable angle that provides, in use, a proper attachment of the dispensing channel 18 (and thus a proper attachment of the base 15 of the closure 10) to a dispensing passage of a container (not shown) to which the closure is, in use, attached.

Particularly, at least an outer part 18a of the dispensing channel 18, which may be defined between an intermediate point 15c of the base 15 and the second end 15b of the base 15, may be provided with outer threads 60, thus the dispensing channel may be removable bolted to a threaded inner part of a dispensing passage of a container (not shown) to which the closure is intended to be connected.

The dispensing channel 18 may comprise one or more cutting elements. In this particular example, a single cutting element 50 is shown (see FIG. 1b). The cutting element 50 may extend from a first end 50a to a second end 50b. The second end 50b extends beyond the second end 15b of the base 15 (and thus beyond a distal end of the dispensing channel 18).

The cutting element 50 may comprise a first cutting edge 50c and a second cutting edge 50d. A pointed cutting element may be situated at a point wherein the first cutting edge 50c and the second cutting edge 50d converge (which corresponds to the second end 50b of the cutting element 50). The first cutting edge 50c, the second cutting edge 50b and the pointed cutting element may be configured to break a seal situated in a container to which, in use, the closure is attached, as will be explained later on.

The cutting element 50 may be made of the same material of the closure 10 and may be integrally formed with the rest of the base 15. However, in some other examples, suitable metals, or polymer plastics, could be used for the construction of the cutting element 50.

The first cutting edge 50a and the second cutting edge 50b are depicted to be substantially straight. This configuration may allow a smooth initial introduction of the cutting element into a sealing membrane forming part of the container to which the closure 10 is intended to be connected.

In some other examples, the cutting element may be a conical cutting element. At the second end 50b, a pointed cutting element may be provided. Similarly as before, the second cutting element may extend beyond the beyond the second end 18b of the dispensing passage 18. The pointed cutting element may be configured to break a seal situated in a container to which, in use, the closure is attached.

Following the example, as commented above, a lid 20 is provided. The lid 20 in this example is substantially circular-shaped. The cover 20 comprises an outer circular sidewall 20a and a base 20b. The base 20b further comprises a bottom surface 20c. The outer sidewall may comprise portions and the portions may be of varying height. The outer circular sidewall 20a further comprises an arcuate recess 20d. The arcuate recess 20d may be shaped so that it may be easily manipulated by the fingers of the user and thus, a user, can easily open and close the lid 20 with respect to the base 15.

The lid 20 may further comprise an annular spigot 20e situated at or near the geometrical centre of the bottom surface 20c. The annular spigot 20e extends substantially perpendicular to the bottom surface 20c. In the “closed” configuration of the closure, the spigot is pushed, and it is situated, at least partially, within the dispensing channel 18 such that the dispensing channel is sealed.

In this respect, the annular spigot 20e may form a male coupling member and the dispensing channel 18 may form a female coupling member adapted to receive the male coupling member such that the dispensing channel is hermetically sealed. In examples, the dispensing channel 18 forms a sealing clip configured to snap fit over the annular spigot 20e of the lid. In any case, the shape and size of the dispensing channel 18 may vary depending on the shape and size of e.g., the annular spigot 20e located e.g., in the lid configured be attached to the base, in the “closed” configuration of the closure 10. With such an arrangement, the lid 20 may be releasably joined to the base 15 using e.g., a snap fit locking mechanism.

The cylindrical sidewall 20a may comprise a grip 20f located at its outer part (see FIG. 1a), thus the insertion, removal and manipulation of the lid 20 with respect to the base 15 may be improved. The grip 20f may be shaped so that it may be easily held between the fingers of the user. The grip 20f may be made of any suitable rough material e.g., plastic polymer, thus the manipulation of the lid 20 by the user may be improved, especially if the outer part of the cylindrical sidewall 20a is wet. With this arrangement, the lid 20 may be easily manipulated and used with great accuracy.

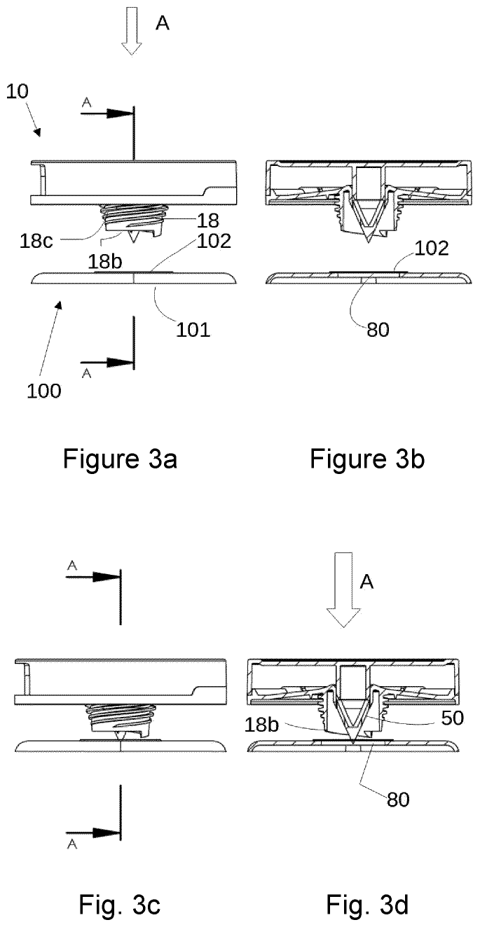

FIGS. 3a-3f illustrates various steps of an example of a method for removably attaching a closure, as hereinbefore described, to a flowable medium container.

FIGS. 3a and 3b illustrate a possible first step in an example of a method of removably attaching a closure (which may be the same as hereinbefore described) to a container configured to contain a flowable medium. FIG. 3a schematically illustrates a perspective view of the closure in an “closed” configuration. FIG. 3b schematically illustrates a section of the closure of FIG. 3a taken along line A-A;

Particularly, a container 100 e.g., a tube to which the closure 10 may be connected is provided. It is noted that, in these figures, only part of the container is depicted.

The container may compromise an inner space 101 configured to store a fluid or another flowable medium. The container 100 may further comprise a dispensing passage 102 for receiving and dispensing a fluid or another flowable medium. The dispensing passage 102 may comprise a threaded inner part (not visible) for a threaded removable engagement with threaded outer part 18c of the dispensing channel 18 of the closure, as will be explained later on.

The container 100 e.g., a teeth paste tube may comprise a sealing element 80 e.g., a sealing membrane. Particularly, the sealing element 80 may be situated within dispensing passage 102 and thus a seal can be defined such that flowable liquid, which can be stored in the inner space 101, cannot pass through the dispensing passage 102. The dimensions of the sealing element 80 are chosen such that the sealing element 80 may be coupled to the inner part of the dispensing passage 102 of the container in a suitable way i.e., sealing the dispensing channel 102 in a suitable way.

Particularly, the sealing element 80 is configured to sealingly couple with an inner portion of the dispensing passage 102 of the container. Therefore, a sealing may be defined such that the flowable product contained in a sealed container space 101, is carried out in substantially aseptic conditions, i.e., avoiding external contaminations, particularly during transport from one point to another point.

The sealing element 80 may be welded or be mechanically attached to an inner portion of the dispensing passage 102. In any event, this may require an external process to assemble the sealing element 80 to the dispensing channel 102 of the container 100.

The sealing element 80 may be formed of any suitable material e.g., polyethylene or polyolefin. The sealing element 80 may be e.g., thinner than 100 microns. In some examples, the seal may be e.g., a membrane and/or a film made of a stretched material configured to be retracted, after puncturing the membrane as will be explained later on, without any material separation. As a result, the sealing element 80 may remain connected to the container, after the seal is punctured, thus improving the recyclability of the closure. In any event, the sealing element 80 guarantees the security of a flowable product which may be situated in the liquid container to which the closure is attached, e.g., under extreme transport conditions.

The container 100 may be made e.g., of paperboard, fibreboard or cardboard. Since the container is made of such materials, the container can be recycled, thus preventing environment destruction. In examples, the container may be made of a recycled material(s) or recyclable material(s).

For a mounting process, it may be beneficial to arrange the second end 18b of the dispensing channel 18 (with a threaded outer part 18c) at or near the opening 102 comprising a threaded inner part.

As commented above, the closure shown in this example may be substantially similar to the one shown in FIGS. 1a and 1b and the same reference signs are used to denote the same components.

The closure 10 may be brought closer to the opening 102 of the container, by a user, in the direction of the arrow (arrow A).

FIGS. 3c and 3d illustrate a possible second step in an example of a method of removably attaching a closure (which may be the same as hereinbefore described) to a flowable medium container. FIG. 3c schematically illustrates a perspective view of the closure in an “closed” configuration. FIG. 3d schematically illustrates a section of the closure of FIG. 3c taken along line A-A.

In this second stage, the second end 18b of the dispensing channel 18 (with a threaded outer part) has already been situated at or near the dispensing opening. The second end 18b of the dispensing channel 18 may further be aligned with respect to the dispensing opening. The closure may be displaced and pushed in the direction of the arrow (arrow A) such the that the closure is coupled to the dispensing opening of the container.

FIGS. 3e and 3f illustrate a possible third step in an example of a method of removably attaching a closure to a flowable medium container. FIG. 3e schematically illustrates a perspective view of the closure in an “closed” configuration. FIG. 3f schematically illustrates a section of the closure of FIG. 3e taken along line A-A;

In this third stage, the dispensing channel 18 (with a threaded outer part 18c) has already been rotatably displaced and bolted to the threaded inner part of the dispending passage 102 such that the sealing element is broken using the cutting elements of the closure and the reusable closure is attached to the dispensing opening of the first container.

As a result, the closure is easily connected to the container. Additionally, by simply bolting the closure to the container, the cutting elements contact and break the seal. As a result, the flowable product can pass through the dispensing passage and can be dispensed via the closure. This type of seal is easier to use and more convenient than the current tear-off ring membranes in the market.

Once the flowable medium contained within the space formed in the container is exhausted, the closure can be removed with respect to the container in a substantially similar way. The container (e.g., made of cardboard) may be disposed (without the closure e.g., made of plastic), thus enabling the container to be properly recycled. Alternatively, the container may be sent to be refilled. Then, the closure can be attached again (and thus reused) in a new cardboard tube with flowable product in it.

### Benefits and Added Values:

increase use of recyclable or recycled materials
full recycling after using

### Sustainability:

recycling after using

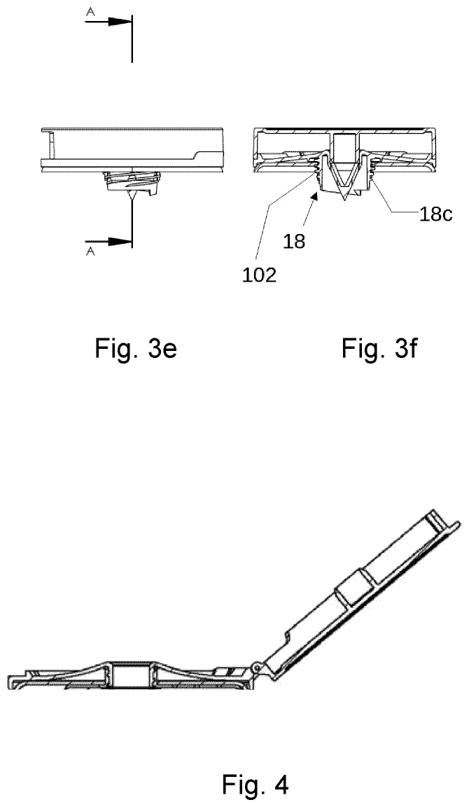

FIG. 4a schematically illustrates a perspective view of another example of a closure in a “closed” configuration. FIG. 4b schematically illustrates a perspective view of the closure described with reference to FIG. 4a in an “open” position.

The closure 1 shown in FIGS. 4a and 4b differs from the closure shown in FIGS. 1-4 only in that the design does not comprise a cutting element. The structure and operation of the remaining components of the closure may substantially be the same as hereinbefore described.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples but should be determined only by a fair reading of the claims that follow.

1. A reusable closure adapted to be removably connected to a dispensing opening of a container, wherein the container is made of paperboard, fiberboard or cardboard, wherein the reusable closure comprises:
a base and a lid, the base and the lid being joint together by a hinge such that the lid is movable between an open position and a closed position, wherein the base extends longitudinally from a first end to a second end, wherein the base comprises:
a flowable medium dispensing passage extending along the longitudinal length of the base between the first end of the base and the second end of the base, wherein, in use, the dispensing passage is adapted to communicate with the dispensing opening of the container,
first coupling elements adapted to mate with second coupling elements forming part of the dispensing opening of the container such that, in use, the closure is attached to the container,
one or more cutting elements configured to break a sealing membrane situated within the opening of the container when the closure is attached to the container such that a flowable medium contained in the container can be dispensed through the dispensing opening of the container.

2. The reusable closure according to claim 1, wherein the reusable closure is a flip-top closure and the lid is integrally formed with the base.

3. The reusable closure according to claim 1, wherein the base further comprises a substantially cylindrical sidewall and an annular top platform, wherein the annular platform includes a platform cylindrical sidewall, wherein the platform cylindrical sidewall is situated radially inwardly with respect to the substantially cylindrical sidewall of the base, wherein the flowable medium dispensing passage is situated at or near the geometric center of the annular top platform.

4. The reusable closure according to claim 1, wherein the hinge is a butterfly hinge comprising at least a wing extending from a first end to a second end, wherein the first end of the wing is attached to the lid and the second end of the wing is rotatably attached to a pivot, using one or more pins, such that the pivot defines a support axis about which the lid pivots with respect to the base.

5. The reusable closure according to claim 1, wherein the first coupling elements correspond to outer threads situated on an outer part of a portion of the flowable medium dispensing passage and the second coupling elements correspond to a threaded inner part of the dispensing opening of the container such that, in use, the portion of the dispensing passage of the closure is removably bolted to the dispensing opening of the container.

6. The reusable closure according to claim 1, wherein the cutting elements comprise a single cutting element including a first cutting edge and a second cutting edge, wherein the first cutting edge and the second cutting edge are substantially straight.

7. The reusable closure according to claim 1, wherein the lid comprises an outer circular sidewall and a base, wherein the base comprises a bottom surface, where the lid further comprises an annular spigot situated at or near the geometrical centre of the bottom surface.

8. The reusable closure according to claim 7, wherein the annular spigot forms a male coupling element and the flowable medium dispensing passage forms a female coupling element adapted to receive the male coupling member such that, when the lid is in the closed position, the annular spigot of the lid is at least partially inserted into the flowable medium dispensing passage thereby hermetically sealing the dispensing passage.

9. The reusable closure according to claim 1, wherein the reusable closure is made of one or more recyclable or recycled materials.

10. A kit comprising:
a container comprising an interior space for housing a flowable product and a dispensing opening for dispensing the flowable product contained in the interior space,
wherein the container is made of paperboard, fiberboard or cardboard,
the reusable closure according to claim 1.

11. The kit according to claim 10, wherein the container comprises second coupling elements which correspond to a threaded inner part of the dispensing opening of the container such that, in use, the portion of the dispensing passage of the reusable closure is removably bolted to the dispensing opening of the container.

12. The kit according to claim 11, wherein the container comprises a sealing element configured to be coupled within the dispensing opening of the container such that the dispensing opening is sealed and the flowable product cannot pass through the dispensing opening.

13. The method for removably attaching a reusable closure to a dispensing passage of a container comprising:
providing the reusable closure according to claim 1,
providing a first container comprising an interior space for housing a flowable product and a dispensing opening for dispensing the flowable product contained in the interior space, wherein the first container is made of paperboard, fiberboard, or cardboard,
coupling a sealing element within the dispensing opening of the first container such that the dispensing opening is sealed and the flowable product cannot pass through the dispensing opening,
bringing the reusable closure and the first container in proximity of each other,
pushing the reusable closure towards the dispensing opening of the first container such that closure is coupled to the dispensing opening of the container,
rotatably displacing the closure in the clockwise direction with respect to the first container such that the sealing element is broken using the cutting elements of the closure and the reusable closure is attached to the dispensing opening of the first container.

14. The method according to claim 13, further comprising:
once the flowable product contained in the interior space of the first container is used, rotatably displacing the closure in the counter clockwise direction such that the closure is detached with respect to the first container,
removing the first container with respect to the closure,
whereby the removed first container can be re-filled and re-used or can be recycled.

15. The method according to claim 14, further comprising:
providing a second container comprising an interior space for housing a flowable product and a dispensing opening for dispensing the flowable product contained in the interior space, wherein the second container is made of paperboard, fiberboard, or cardboard, specifically the second container has been previously re-filled with the flowable product,
coupling a sealing element within the dispensing opening of the second container such that the dispensing opening is sealed and the flowable product cannot pass through the dispensing opening,
bringing the reusable closure and the second container in proximity of each other,
pushing the reusable closure towards the dispensing opening of the container such that closure is coupled to the dispensing opening of the container,
rotatably displacing the reusable closure in the clockwise direction with respect to the first container such that the sealing element is broken using the cutting elements of the reusable closure and the reusable closure is attached to the dispensing opening of the second container.
